(19) United States
(12) Patent Application Publication
(10) Pub. No.: US 2004/0174367 A1
(43) Pub. Date: Sep. 9, 2004

(54) System and method for processing real-time video streams

(76) Inventor: Li-Hsiang Liao, Zhongli City (TW)

Correspondence Address: RABIN & Berdo, PC, 1101 14TH STREET, NW, SUITE 500, WASHINGTON, DC, 20005, US

(21) Appl. No.: 10/793,033

(22) Filed: Mar. 5, 2004

(30) Foreign Application Priority Data
Mar. 7, 2003 (TW) 92104994

(51) Int. Cl. G06T 15/70

(52) U.S. Cl. 345/473

(57) ABSTRACT

A method and system for processing real-time video streams. The method displays pictures, stored in a back buffer, played by a video player application in a 3D animation scene through a shared memory and a 3D texture mapping method while a 3D animation program has been executed, such that the combined image fills the entire display monitor.

### BACKGROUND OF THE INVENTION

1. Field of the Invention

The present invention relates to a system and method for data processing, and in particular to a system and method for processing real-time video streams.

2. Description of the Related Art

One method of achieving the serial effect required by the persistence of vision effect deriving animation playback comprises alternating data between the front and back buffers in a display buffer.

A front buffer is visible, and displays video data on a display device, while a back buffer is invisible, and stores blocks in memory. Video data stored therein is automatically flipped between the front buffer and back buffer, and transferred from back buffer to front buffer.

Another method of achieving the effect known as above is block blitting, is regarded as more effective and is in common use.

3D graphic design simulates objects by utilizing complex mechanisms or models to mirror behaviors of real objects in a 3D animation scene for projection and display on a two-dimensional (2D) monitor.

Objects are modeled with dots, lines, and surfaces, using 3D coordinates (X, Y, Z), which are enlarged, minimized, moved, and deformed, by linear algebra. FIGS. 1A˜1E are schematic diagrams showing the conventional method for generating 3D animation. Vertex data of a 3D object, including a coordinate (X, Y, Z), colors (RGBA), textures, and a coordinate (U, V), are transformed to coordinates (Xₛ, Yₛ, Zₛ) on the screen. Lighting effects, such as RₛGₛBₛAₛ colors, are transformed by view port clipping, and scaling, as shown in FIG. 1A, wherein Xₛ and Yₛ refer to screen coordinates and Zs refers to depth of field. A screen coordinate (Xₚ, Yₚ, Zₚ) of each pixel is generated according to the screen coordinate (Xₛ, Yₛ, Zₛ), as shown in FIG. 1B, a color RₚGₚBₚAₚ of each pixel is generated according to the lighted color RₛGₛBₛAₛ, as shown in FIG. 1C. Next, a color RₜGₜBₜAₜ on textures is obtained with respect to the coordinate (U, V) by texture mapping and an object color RₒGₒBₒAₒ is then generated by a blending the colors RₚGₚBₚAₚ and RₜGₜBₜAₜ, as shown in FIG. 1D. Next, a desired color R_{f}G_{f}B_{f}A_{f} of the 3D object, as shown in FIG. 1E, is generated by blending the colors RₒGₒBₒAₒ and R_{d}G_{d}B_{d}A_{d} stored in the current display buffer, and the pixel of a coordinate (Xₚ, Yₚ) is drawn with the color R_{f}G_{f}B_{f}A_{f}. The steps above are repeated until the entire 3D animation scene is generated.

Current 3D animation games are displayed in full screen on monitors to enhance game effects. Video applications, however, cannot be simultaneously displayed in a 3D animation scene. A conventional method to solve the problem is to connect an external video mixer to mix video signals and input signals from the computer system. This method, however, is incapable of processing video streams from the Internet.

### SUMMARY OF THE INVENTION

Accordingly, an object of the present invention is to provide a method for processing real-time video streams, displaying video streams played by a video player application in a 3D animation scene using a method for 3D texture mapping with a shared memory.

According to the object described above, the present invention provides a method for processing real-time video streams. First, addresses of a shared memory shared by a 3D animation program and a video player application are defined. Video data is obtained through the video player application and is then copied to the shared memory. The computer system determines whether the 3D animation program is being executed while the video player application is executed, and, if so, the video data retrieved from a video source is copied to the shared memory. Next, a driver of the 3D animation program determines whether the 3D animation program has drawn a refreshed picture to a back buffer, and, if so, the video data stored in the shared memory is loaded to a video memory. Finally, the video data is blended with the refreshed picture stored in the back buffer, in which the refreshed picture and the video data is displayed on a display device.

### BRIEF DESCRIPTION OF THE DRAWINGS

The present invention can be more fully understood by reading the subsequent detailed description and examples with references made to the accompanying drawings, wherein:

FIG. 1A˜1E are schematic diagrams showing the conventional method for generating 3D animation;

FIG. 2 is a schematic diagram showing the shared memory for data communication between a 3D animation program and a video player application according to the present invention;

FIG. 3 is schematic diagram showing the architecture of the system for processing real-time video streams according to the present invention;

FIG. 4 is a flowchart showing the detailed steps of the method for retrieving video data from a video source through a video player application according to the present invention; and

FIG. 5 is a flowchart showing the detailed steps of the method for processing real-time video streams according to the present invention.

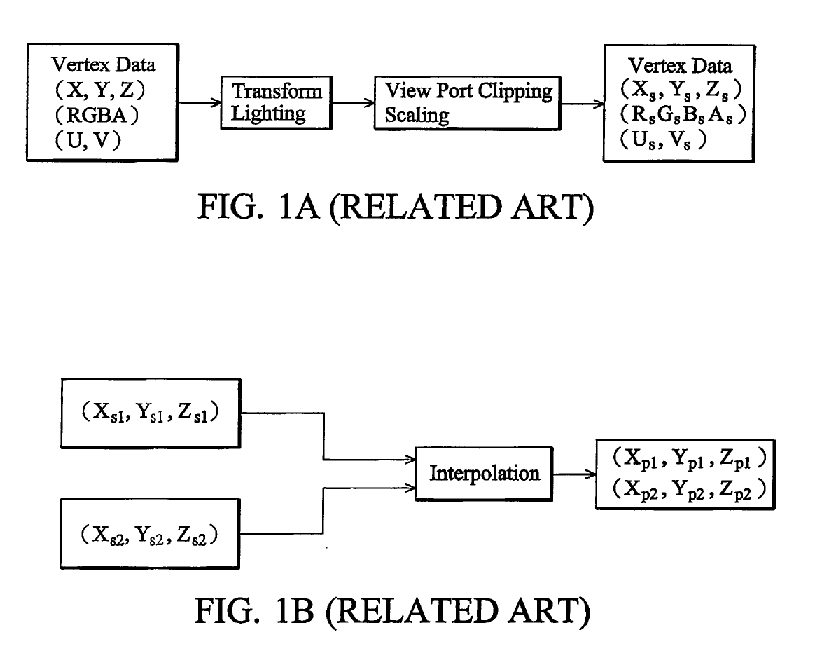

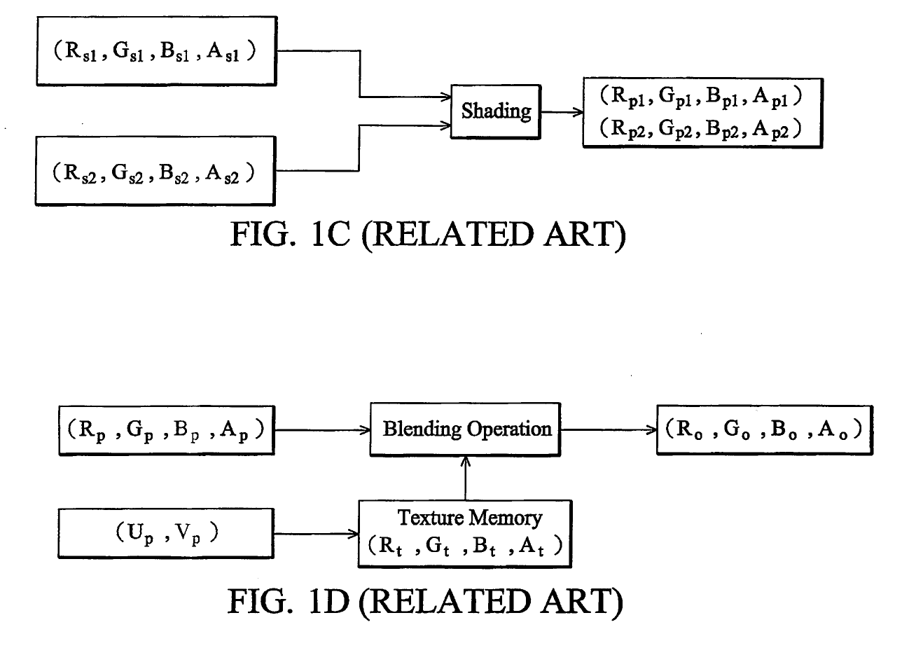

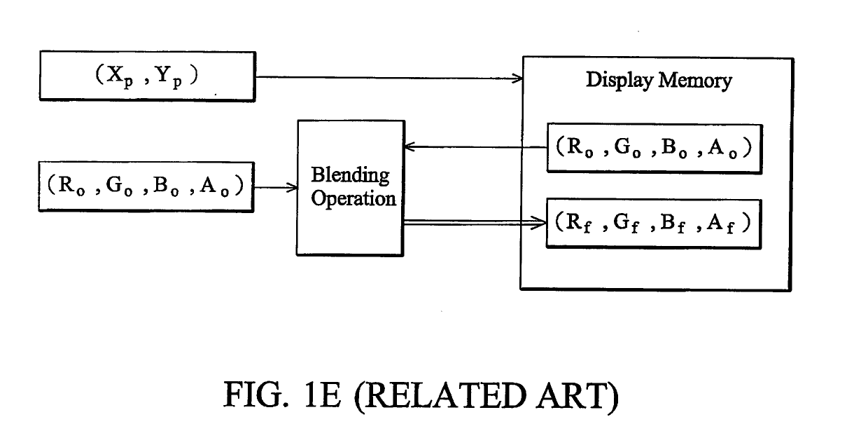

### DETAILED DESCRIPTION OF THE INVENTION

The present invention discloses a method and system for processing real-time video streams. A 3D animation program calls an application programming interfaces (API) to display pictures on a monitor when finished drawing a 3D animation scene, combining and drawing pictures retrieved from video streams to the 3D animation scene by a 3D texture mapping method. A video player application receives refreshed pictures from the video streams repeatedly to be displayed while the 3D animation program is executed.

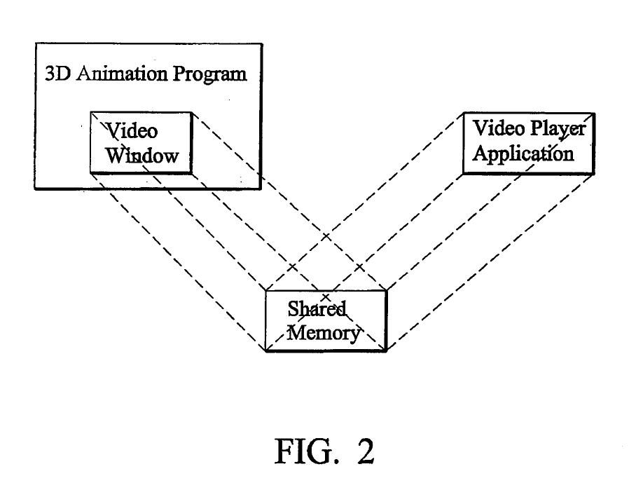

FIG. 2 is a schematic diagram showing the shared memory for data communication between a 3D animation program and a video player application according to the present invention. Both the 3D animation program and video player application are independent applications that cannot share resources, they must communicate video data through a shared memory to be displayed in a 3D animation scene with a video window object.

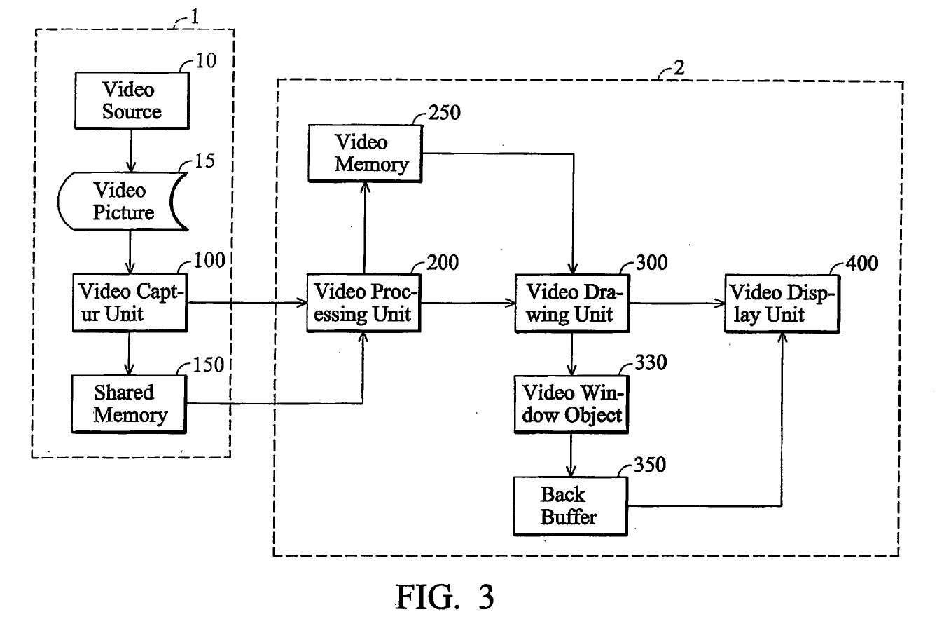

FIG. 3 is schematic diagram showing the architecture of the system for processing real-time video streams according to the present invention. The architecture comprises a video player module 1, having a video capture unit 100, and a 3D animation module 2, having a video processing unit 200, a video drawing unit 300, and a video display unit 400.

Video capturing unit 100 retrieves a video picture 15 from a video source 10, automatically copying video picture 15 to a shared memory 150 while a 3D animation program is executed, such that the combined image data fills the entire display monitor, and informs a computer system to refresh video data. Video processing unit 200 loads video picture 15 from shared memory 150 to video memory 250, in which video picture 15 is represented as texture. Video drawing unit 300 creates a video window object 330 for displaying video picture 15, drawing the texture (video picture 15) and video window object 330 to a back buffer 350 using a 3D texture mapping method. Finally, video picture 15 is displayed with video window object 330 through video displaying unit 400 while APIs of the computer system are called.

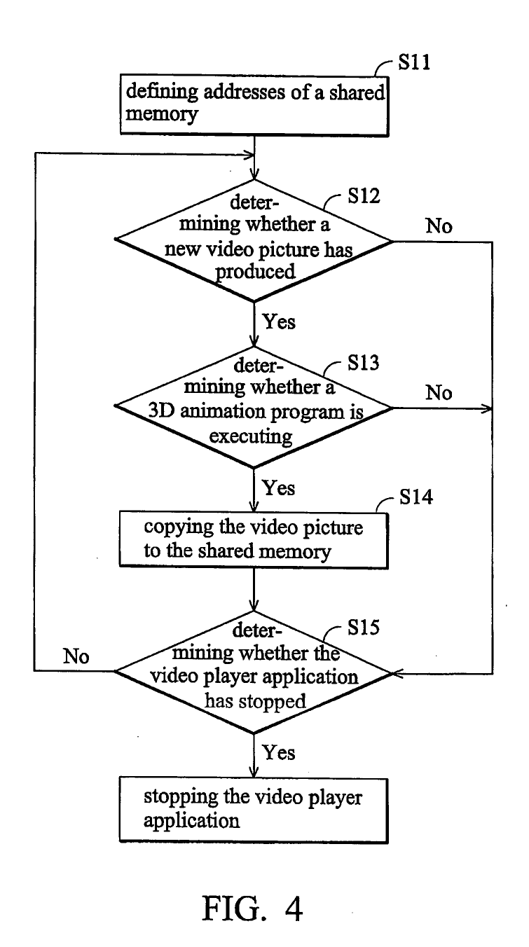

FIG. 4 is a flowchart showing the detailed steps of the method for retrieving video pictures from a video source through a video player application according to the present invention.

In step S11, addresses of a shared memory are defined for access by a video player application.

In step S12, the video player application determines whether a new video picture has been created, and, if so, the process goes to step S13, and, if not, the process goes to step S15.

In step S13, a computer system determines whether a 3D animation program is executed while the new video picture is produced, and, if so, the process goes to step S14, and, if not, the process goes to step S15.

In step S14, the video picture is copied to the shared memory while the 3D animation program is executed, and a video refreshing flag is then set to determine whether there are video pictures in the shared memory. If so, the value of the video refreshing flag is initialized to one, and, if not, initialized to zero.

In step S15, the computer system determines whether the video player application has stopped. The video player application is determined as stopped if no video picture has been retrieved from the video source, or the process goes to step S12 to continue the video picture generating procedure.

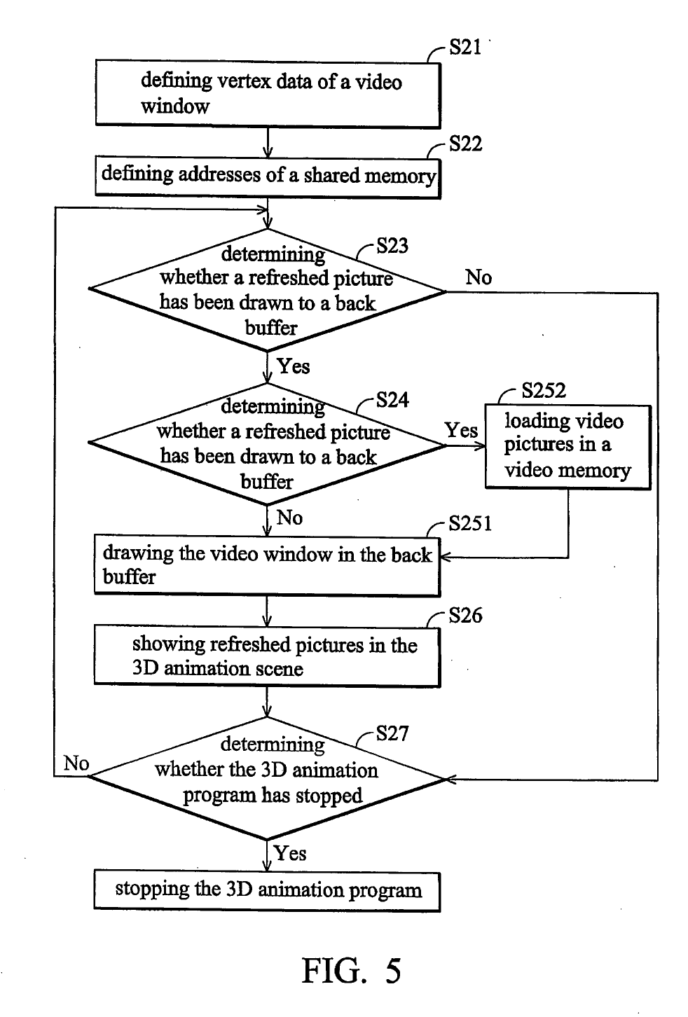

FIG. 5 is a flowchart showing the detailed steps of the method for processing real-time video streams according to the present invention.

In step S21, vertex data of a video window is defined to determine the size and location of the video window in a 3D animation scene. It should be noted that the step S21 is optional in that values of the size and location can be predetermined or fixed so that vertex data need not to be defined.

In step S22, addresses of a shared memory are defined to be accessed by a 3D animation program.

In step S23, the 3D animation program determines whether a refreshed picture has been drawn to a back buffer. A first driver and a sub-program thereof used to draw the refreshed picture are obtained by a computer system. The first driver is loaded to a memory of the computer system through a second driver to obtain an entry point for the sub-program. The second driver is registered in the computer system for replacing the first driver, determining whether the refreshed picture has been drawn, and, if so, the process goes to step S24, and, if not, the process goes to step S27.

In step S24, the 3D animation program determines whether the shared memory stores video pictures according to a video refreshing flag, and, if so, the process goes to step S251, and, if not, the process goes to step S252.

In step S251, the video window is drawn to the back buffer if no video picture is stored in the shared memory.

In step S252, video pictures are loaded from the shared memory to a video memory of a 3D graphic card, and the video window and the video picture are added to the refreshed picture, thus initializing the value of the video refreshing flag to 0.

In step S26, the refreshed picture with the video window and the video picture stored in the back buffer are displayed in the 3D animation scene by executing flipping operations.

In step S27, the computer system determines whether the 3D animation program has stopped. If so, the program is determined as stopped, and, if not, the process goes to step S23 to continue the process.

The method of the present invention displays pictures, stored in a back buffer, played by a video player application in a 3D animation scene through a shared memory and a 3D texture mapping method while a 3D animation program is executed, such that the combined image fills the entire display monitor.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for processing real-time video streams for a computer system, executing a three-dimensional (3D) animation program and a video player application, comprising the steps of:
defining addresses of a shared memory shared by the 3D animation program and the video player application;
obtaining a video picture through the video player application;
copying the video picture to the shared memory;
determining whether the 3D animation program has drawn a refreshed picture to a back buffer;
loading the video picture from the shared memory to a video memory when the 3D animation program has completed a drawing step;
blending the video picture with the refreshed picture stored in the back buffer; and
displaying the refreshed picture with the video picture on a display device.

2. The method as claimed in claim 1, wherein the video picture stored in the video memory is represented as texture.

3. The method as claimed in claim 1, wherein the display step is implemented by a method for 3D texture mapping.

4. The method as claimed in claim 1, wherein the video picture is displayed by a video window object.

5. The method as claimed in claim 1, wherein the obtaining step further comprises the steps of:
retrieving the video picture from a video source; and
copying the video picture to the shared memory while the 3D animation program is executed.

6. The method as claimed in claim 1, wherein the determining step is implemented by implementing a second driver, comprising the steps of:
obtaining a first driver and a sub-program thereof through the computer system;
loading the first driver to a memory of the computer system using the second driver;
obtaining an entry point of the sub-program; and
registering the second driver in the computer system for replacing the first driver.

7. The method as claimed in claim 6, wherein the first driver refers to an original driver of the computer system that executes the 3D animation program.

8. A method for processing real-time video streams, performing a 3D animation program of a computer system, comprising the steps of:
defining addresses of a shared memory;
determining whether the 3D animation program has drawn a refreshed picture to a back buffer;
loading a video picture from the shared memory to a video memory when the 3D animation program has completed a drawing step;
blending the video picture with the refreshed picture stored in the back buffer; and
displaying the refreshed picture with the video picture on a display device.

9. The method as claimed in claim 8, wherein the video picture stored in the video memory is represented as texture.

10. The method as claimed in claim 8, wherein the displaying step is implemented by a method for 3D texture mapping.

11. The method as claimed in claim 8, wherein the video picture is displayed by a video window object.

12. The method as claimed in claim 8, wherein the determining step is implemented by implementing a second driver, comprising the steps of:
obtaining a first driver and a sub-program thereof through the computer system;
loading the first driver to a memory of the computer system using the second driver;
obtaining an entry point of the sub-program; and
registering the second driver in the computer system for replacing the first driver.

13. The method as claimed in claim 12, wherein the first driver refers to an original driver of the computer system that executes the 3D animation program.

14. A system for processing real-time video streams for a computer system, performing a 3D animation program and a video player application, comprising:
a video play module, defining addresses of a shared memory shared by the 3D animation program and the video player application, obtaining a video picture through the video player application, and copying the video picture to the shared memory; and
a 3D animation module, coupled to the video player module, loading a video picture from the shared memory to a video memory when the 3D animation program has drawn a refreshed picture in a back buffer, blending the video picture with the refreshed picture stored in the back buffer, and displaying the refreshed picture with the video picture on a display device.

15. The system as claimed in claim 14, wherein the video picture stored in the video memory is represented as a texture.

16. The system as claimed in claim 14, wherein the refreshed picture is displayed by a method for 3D texture mapping.

17. The system as claimed in claim 14, wherein the video picture is displayed by a video window object.

18. The system as claimed in claim 14, wherein the video picture is retrieved from a video source, and the video picture is then copied to the shared memory while the 3D animation program is executed.

19. The system as claimed in claim 14, wherein the 3D animation module further obtains a first driver and a sub-program thereof through the computer system, loads the first driver to a memory of the computer system using the second driver, obtains an entry point of the sub-program, and registers the second driver in the computer system for replacing the first driver.

20. The system as claimed in claim 19, wherein the first driver refers to an original driver of the computer system that executes the 3D animation program.

21. A storage medium for storing a computer program providing a method for processing real-time video streams, comprising using a computer to perform the steps of:
defining the address of a shared memory shared by the 3D animation program and the video player application;
obtaining a video picture using the video player application;
copying the video picture to the shared memory;
determining whether the 3D animation program has drawn a refreshed picture in a back buffer;
loading the video picture from the shared memory in a video memory when the 3D animation program has drawn the refreshed picture in the back buffer;
adding the video picture to the refreshed picture in the back buffer; and
displaying the refreshed picture comprising the video picture on a display device.

22. The storage medium as claimed in claim 21, wherein the video picture stored in the video memory is represented as texture.

23. The storage medium as claimed in claim 21, wherein the refreshed picture is displayed by a method for 3D texture mapping.

24. The storage medium as claimed in claim 21, wherein the video picture is displayed by a video window object.

25. The storage medium as claimed in claim 21, wherein the video picture is retrieved from a video source, and the video picture is copied to the shared memory deriving execution of the 3D animation program.

26. The storage medium as claimed in claim 21, wherein a first driver and a sub-program thereof is obtained through the computer system, the first driver is loaded to a memory of the computer system using the second driver, an entry point of the sub-program is obtained, and the second driver is registered in the computer system for replacing the first driver.

27. The storage medium as claimed in claim 26, wherein the first driver refers to an original driver of the computer system that executes the 3D animation program.

28. A method for processing real-time video streams for a computer system, performing a 3D animation program and a video player application providing a video picture, comprising the steps of:
copying the video picture to a shared memory;
loading the video picture from the shared memory to a video memory;
blending the video picture with a refreshed picture stored in a back buffer; and
displaying the refreshed picture with the video picture on a display device.

29. The method as claimed in claim 28 further comprising a step of defining addresses of the shared memory from and in which the 3D animation program and the video player application can read and write.

30. The method as claimed in claim 28, wherein the loading step further comprises the steps of:
determining whether the 3D animation program has drawn a refreshed picture to a back buffer; and
loading the video picture from the shared memory to a video memory when the 3D animation program has drawn the refreshed picture to the back buffer.

31. A system for processing real-time video streams for a computer system, performing a 3D animation program and a video player application providing a video picture, comprising:
a video player module, copying the video picture to a shared memory; and
a 3D animation module, coupled to the video player module, providing a 3D animation, blending the video picture with the 3D animation for obtaining a refreshed picture, and displaying the refreshed picture on a display device.

32. The system as claimed in claim 31, wherein the 3D animation module is a 3D animation engine.
